(19) United States
(12) Patent Application Publication
(10) Pub. No.: US 2025/0071843 A1
(43) Pub. Date: Feb. 27, 2025

(54) BLUETOOTH CONNECTION SYSTEM AND BLUETOOTH CONNECTION METHOD

(71) Applicant: BENQ CORPORATION, Taipei City (TW)

(72) Inventors: Chih-Hung LIN, Taipei City (TW); Chen-Chen TSAI, Taipei City (TW)

(73) Assignee: BENQ CORPORATION, Taipei City (TW)

(21) Appl. No.: 18/761,423

(22) Filed: Jul. 2, 2024

(30) Foreign Application Priority Data
Aug. 24, 2023 (TW) 112131879

(51) Int. Cl. H04W 76/18; H04W 52/02; H04W 76/14

(52) U.S. Cl. CPC H04W 76/18; H04W 52/0229; H04W 76/14

(57) ABSTRACT

A Bluetooth connection system is provided. The Bluetooth connection system includes a control host and a Bluetooth audio device. The control host includes a transmission unit. The Bluetooth audio device wirelessly communicates with the transmission unit, wherein the control host receives an instruction, then turns on the transmission unit and executes a search task to find the Bluetooth audio device around the control host. When the Bluetooth audio device does not return a confirmation Bluetooth connection signal to the control host, the control host sends a wake-up signal to the Bluetooth audio device to start a re-pairing procedure.

This application claims the benefit of Taiwan application Serial No. 112131879, filed Aug. 24, 2023, the subject matter of which is incorporated herein by reference.

### BACKGROUND OF THE INVENTION

### Field of the Invention

The present application relates in general to a communication system, and more particularly to a Bluetooth connection system and a Bluetooth connection method.

### Description of the Related Art

Currently, the Bluetooth device needs to be paired before it can be used, and the pairing action must be started by the computer host. The user needs to perform a number of operations before he/she can use the microphone/speaker functions of the Bluetooth device. For a user who is not versed with the computer, this is indeed inconvenient. For instance, when the user is at a meeting or wants to listen to the music, the Bluetooth device cannot be automatically switched to the user's desired mode to serve the user.

### SUMMARY OF THE INVENTION

The present application is directed to a Bluetooth connection system and a Bluetooth connection method capable of completing Bluetooth pairing and setting easily.

According to one embodiment of the present application, a Bluetooth connection system is provided. The Bluetooth connection system includes a control host and a Bluetooth audio device. The control host includes a transmission unit. The Bluetooth audio device wirelessly communicates with the transmission unit, wherein the control host receives an instruction, then turns on the transmission unit and executes a search task to find the Bluetooth audio device around the control host, wherein the instruction is sent by an application program or the Bluetooth audio device. When the Bluetooth audio device does not return a confirmation Bluetooth connection signal to the control host, the control host sends a wake-up signal to the Bluetooth audio device to start a re-pairing procedure.

According to another embodiment of the present application, a Bluetooth connection method is provided. The Bluetooth connection method includes the following steps. An instruction is received by a control host to turn on a transmission unit and execute a search task to find a Bluetooth audio device around the control host, wherein the instruction is sent by an application program or the Bluetooth audio device. Whether the Bluetooth audio device returns a confirmation Bluetooth connection signal is determined. When it is determined that the Bluetooth audio device does not return the confirmation Bluetooth connection signal to the control host, the control host sends a wake-up signal to the Bluetooth audio device to start a re-pairing procedure. The Bluetooth audio device is paired with the control host.

The above and other aspects of the present application will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a Bluetooth connection system according to an embodiment of the present application.

FIG. 2A is a flowchart of a Bluetooth connection method according to an embodiment of the present application.

FIG. 2B is a flowchart of a Bluetooth setting method according to an embodiment of the present application.

### DETAILED DESCRIPTION OF THE INVENTION

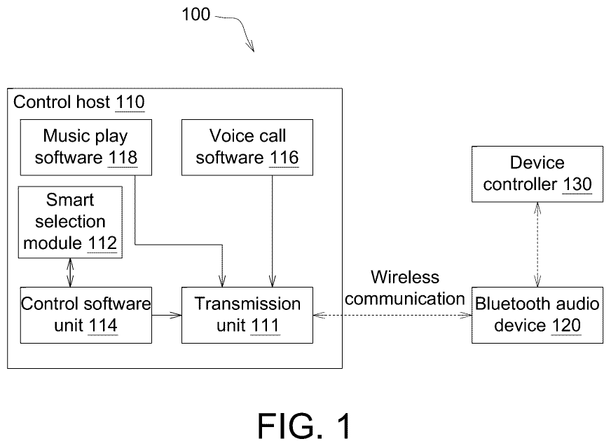

Referring to FIG. 1, a schematic diagram of a Bluetooth connection system 100 according to an embodiment of the present application is shown. The Bluetooth connection system 100 includes a control host 110 and a Bluetooth audio device 120. The control host 110 may include a computer host, a play host, or other hand-held electronic devices, such as mobile phone, tablet, game console or smart watch. The Bluetooth audio device 120 may include a Bluetooth headset, a Bluetooth speaker or other audio devices.

In an embodiment, the control host 110 includes a transmission unit 111. The Bluetooth audio device 120 also includes a transmission unit (not illustrated), so that the transmission unit 111 of the Bluetooth audio device 120 can wirelessly communicate with the transmission unit 111 of the control host 110. For instance, the control host 110 communicates with the Bluetooth audio device 120 through ultra-high frequency (UHF) radio waves at the ISM band of 2.4 to 2.485 GHz. Bluetooth can be used for the wireless connection between devices, for instance, between a computer and a peripheral device such as printer, keyboard, and so on. Also, Bluetooth technology allows a personal digital assistant (PDA), a mobile phone, or a PDA to communicate with a device nearby. A mobile phone equipped with Bluetooth function can be connected to a computer, a PDA or a hands-free headset (wireless microphone and headphone).

Besides, the control host 110 may further include a smart selection module 112, a control software unit 114, a voice call software 116 and a music play software 118. The smart selection module 112 can switch the audio transmission mode of the Bluetooth audio device 120 according to scenario of use. For instance, the smart selection module 112 can select to turn on the call mode when the user is having a meeting at the office or turn on the music play mode when the user wants to listen to high-quality music. Also, the control software unit 114 is used to control the voice call software 116 supporting the hands-free profile mode 122 and control the music play software 118 supporting the A2DP mode 124 (A2DP mode is an abbreviation for advanced audio distribution profile mode) to play an audio source. Examples of the voice call software 116 include online voice/video calling software such as Google meet, Microsoft Teams, and Skype; examples of the music play software 118 include music streaming software such as Windows Media player or YouTube, KKBOX.

One purpose of the present application is to provide a method for connecting the control host 110 to the Bluetooth audio device 120 and a method for setting the audio transmission mode. In an embodiment, the smart selection module 112 can be trained using neural network, and can be formed of artificial intelligence computing chips, circuits and/or software. The control software unit 114 can be formed of control chips, circuits and/or software. The transmission unit 111 can be realized by a transmitter and a receiver, which support two-way transmission.

In the regard of pairing connection, the pairing of a conventional Bluetooth device must be activated by a computer host, and it takes several operations for the target device to be located and paired. It is inconvenient for a user not versed with computer to perform these operations. At the end, the user would not be able to use the Bluetooth device.

To resolve the above problems, the Bluetooth audio device 120 of the present embodiment can start a pairing procedure when the user presses the Bluetooth pairing key (with only one click). Moreover, the Bluetooth audio device 120 can transmit relevant instruction and data to the control host 110 through Bluetooth signals (BLE). Then, the control host 110 starts the pairing procedure to complete pairing connection. When pairing connection is completed, the control host 110 can turn the predetermined audio playback device to face the Bluetooth audio device 120, so that the pairing time can be reduced.

The Bluetooth audio device 120 of the present embodiment may include an input device (such as press key or touch pad), a monitor and/or an indicator. The Bluetooth audio device 120 can receive control instruction and data from the control host 110 and the device controller 130 to perform corresponding actions; the Bluetooth audio device 120 can also send control instruction, state or relevant data to the control host 110 and the device controller 130. In this way, two-way control can be achieved. Thus, when the control host 110 receives an instruction from an application program or the Bluetooth audio device 120, the control host 110 can turn on the pairing procedure then select the audio transmission mode according to the current scenario of use or the user can press a key on the Bluetooth audio device 120 to quickly switch the audio transmission mode. In this way, the “Press and Play” effect can be achieved.

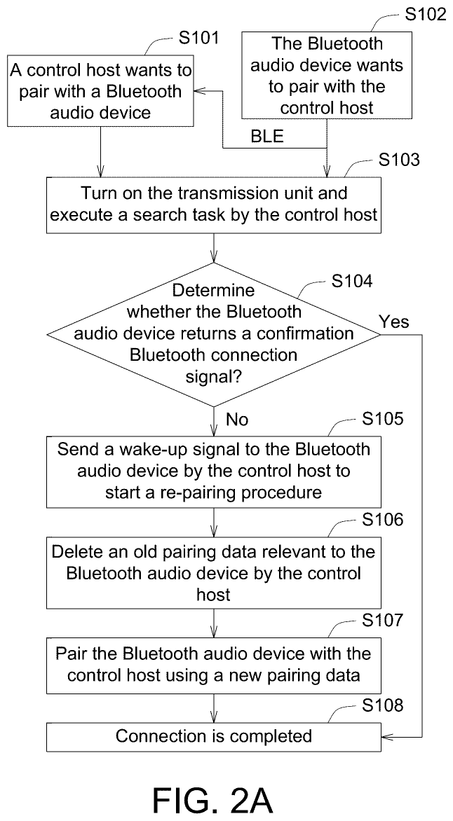

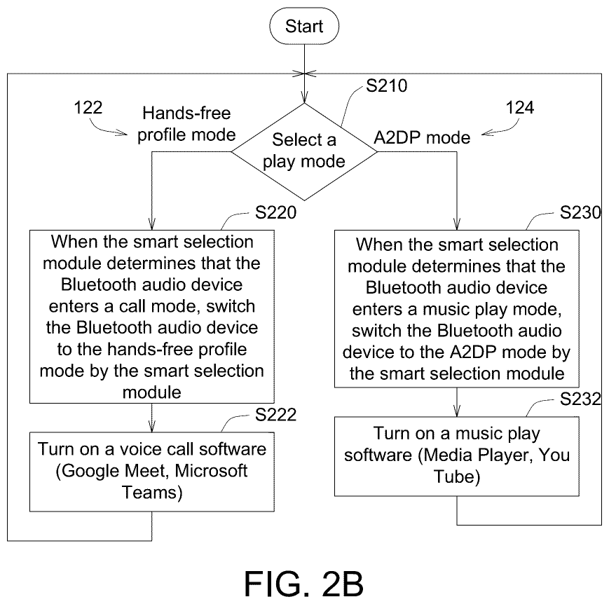

Refer to FIGS. 1 and 2A. FIG. 2A is a flowchart of a Bluetooth connection method according to an embodiment of the present application. In steps S101 and S102, when the control host 110 wants to pair with the Bluetooth audio device 120 or when the Bluetooth audio device 120 wants to pair with the control host 110, an instruction is received by the control host 110, wherein the instruction can be sent by an application program or the Bluetooth audio device 120. In step S103, a transmission unit 111 is turned on and a search task is executed by the control host 110 to find a Bluetooth audio device 120 around the control host 110. In step S104, whether the Bluetooth audio device 120 returns a confirmation Bluetooth connection signal is determined by the control host 110. When it is determined that the Bluetooth audio device 120 returns a confirmation Bluetooth connection signal to the control host 110, this indicates that connection is completed (step S108). In step S105, when it is determined that the Bluetooth audio device 120 does not return a confirmation Bluetooth connection signal to the control host 110, a wake-up signal is sent to the Bluetooth audio device 120 by the control host 110 to start a re-pairing procedure.

In an embodiment, if the Bluetooth audio device 120 cannot be connected back to the control host 110 automatically, this indicates that the pairing data stored in the control host 110 does not match the pairing data of the Bluetooth audio device 12 or system setting is inconsistent. Under such circumstance, the control host 110 cannot automatically find the Bluetooth audio device 120, and the pairing connection fails. A solution is provided in step S106. In step S106, an old pairing data relevant to the Bluetooth audio device 120 is detected by the control host 110 and a new pairing data is accessed from the Bluetooth audio device 120 again. In step S107, the Bluetooth audio device 120 and the control host 110 are paired using the new pairing data. Thus, the problem of the Bluetooth audio device 120 failing to connect back to the control host 110 automatically can be resolved.

The above steps show that when the control host 110 pairs with the Bluetooth audio device 120 using the new pairing data, the pairing procedure can be simplified, and the user's inconvenience can be alleviated. Meanwhile, the new pairing data will be stored in the control host 110. Next time, when the Bluetooth audio device 120 needs to automatically connect back, the Bluetooth audio device 120 only needs to return a confirmation Bluetooth connection signal to the control host 110 without going through the pairing procedure again. In this way, the pairing time will be reduced.

Here below, the selection of play mode is exemplified by a conference call mode. Conventionally, it takes several operations for the user to successfully perform speaker/microphone functions using a Bluetooth device. In the embodiment, through the one-click switch function of an application program, the audio transmission mode can be smartly selected according to the current scenario of use, or the user can quickly switch to the audio transmission mode by clicking one press key on the Bluetooth audio device. In this way, the user will be more willingly to use relevant Bluetooth audio device.

Generally speaking, the Bluetooth audio device 120 can support both hands-free profile mode 122 and A2DP mode 124 (A2DP is an abbreviation for advanced audio distribution profile mode). The hands-free profile mode 122 allows calls and plays mono sound, but the audio quality is not high; therefore, the hands-free profile mode 122 is not suitable for playing high-quality audio source. The A2DP mode can support various audio encoding formats, such as MPEG-1, MPEG-2, MPEG-4, AAC, ATRAC, SBC, aptX, LDAC, and therefore is suitable for playing high-quality audio source.

The Bluetooth headsets of the early stages have narrow bandwidth in wireless transmission and the voice play is limited to mono mode, and therefore they are mostly used in the hands-free headset function for voice calls. It is not until the quality and efficiency of wireless transmission are greatly improved due to the advance of Bluetooth technology that stereo Bluetooth headsets become popular. However, the scenario where the current Bluetooth audio device 120 bothers the user most is as follows: In the meeting, the computer host pre-sets the Bluetooth audio device 120 to microphone function, but the pre-determined audio play device is not synchronically set to the hands-free profile mode 122. As a result, the other party can hear the user's voice, but the user cannot hear the other party's, therefore the meeting cannot go on. The other scenario is that when the call already ends and the user would like to listen to the music using the Bluetooth audio device 120, but the pre-determined audio play device of the computer host is not synchronically set to the A2DP mode 124. As a result, the experience of listening to the music is not enjoyable, making the user doubt the quality of the Bluetooth audio device 120, and poor user experience will lead to an increase in the cost of customer service.

To resolve the above problems, the smart selection module 112 of the present embodiment can adopt one of the following methods: Storing the user's use habits or suggesting a profile to the control software unit 114 according to the software in use at the specific scenario. The storing of user's use habits includes: (1) Recording whether there are any switches or adjustments during the profile adopted in the computer software. (2) Downloading from the Internet the software and corresponding profile that have been analyzed through big data analysis. For instance, the music play software 118 will use A2DP mode, and the on-line meeting software (such as Google meet) will use hands-free profile mode. (3) Uploading relevant data for big data analysis.

Besides, the control software unit 114 of the present embodiment can adopt one of the following methods: (1) Controlling the transmission unit 111 by the operating system of the computer host. (2) Changing the pre-set audio device used in the input and output of an audio source by the operating system of the computer host. (3) If the user selects automatic switching, performing switching according to the according to the profile suggested by the smart selection module 112. (4) Returning the software and profile in use to the smart selection module 112 by the control software unit 114.

Refer to FIGS. 1 and 2B. FIG. 2B is a flowchart of a Bluetooth setting method according to an embodiment of the present application. In step S210, a play mode is selected. The play mode includes a hands-free profile mode 122 and an A2DP mode 124. In step S220, when the smart selection module 112 determines that the Bluetooth audio device 120 enters a call mode, the Bluetooth audio device 120 is switched to the hands-free profile mode 122 by the smart selection module 112. In step S230, when the smart selection module 112 determines that the Bluetooth audio device 120 enters a music play mode, the Bluetooth audio device 120 is switched to the A2DP mode 124 by the smart selection module 112. Besides, the control software unit 114 can select to turn on the voice call software 116 or the music play software 118 according to a switch instruction received from the smart selection module 112 (or the device controller 130). For instance, in step S222, in the call mode, the voice call software 116 is automatically turned on by the control software unit 114. In step S232, in the music play mode, the music play software 118 is automatically turned on by the control software unit 114.

In step S222, when the smart selection module 112 determines that the Bluetooth audio device 120 ends the call mode (return to step S210) and enters the music play mode (proceed to step S230), the Bluetooth audio device 120 is automatically switched from the hands-free profile mode 122 to the A2DP mode 124 by the smart selection module 112 (or the device controller 130). In step S232, when the smart selection module 112 determines that the Bluetooth audio device 120 ends the music play mode (return to step S210) and enters the call mode (proceed to step S220), the Bluetooth audio device 120 is automatically switched from the A2DP mode 124 to the hands-free profile mode 122 by the smart selection module 112 (or the device controller 130). In another embodiment, when the connection between the control host 110 and the Bluetooth audio device 120 is discontinued, the smart selection module 112 (or the device controller 130) automatically ends the call mode or the music play mode then returns to step S210.

According to the Bluetooth connection system and the Bluetooth connection and setting method of the present application, the smart selection module 112 suggests a suitable profile to the control software unit 114 according to the scenario of use and/or according to the software in use, so that the user's erroneous setting of the device will not disable the microphone/speaker functions of the Bluetooth audio device 120 or affect the user's enjoyment of listening to the music.

Refer to FIG. 1. The Bluetooth audio device 120 also can switch between different profiles through its input device or according to the instruction and data received from the device controller 130 (such as a mobile phone or a tablet computer). For instance, the Bluetooth audio device 120 can switch from the A2DP mode 124 to the hands-free profile mode 122, or from the hands-free profile mode 122 to the A2DP mode 124. Moreover, after receiving instruction and data from the device controller 130, the Bluetooth audio device 120 can return a switch instruction to the control host 110 to change the pre-setting of the microphone/speaker device. Subsequently, the control host 110 can perform the pre-setting of the microphone/speaker device according to the user's setting.

In step S210 of FIG. 3, the selection of the play mode can also be done by the device controller 130; it does not have to be done by the smart selection module 112. In an embodiment, the device controller 130 can wirelessly communicate with the Bluetooth audio device 120, then switches the audio transmission mode of the Bluetooth audio device 120 according to a scenario of use. For instance, the device controller 130 also can switch between the hands-free profile mode 122 and the A2DP mode 124. In step S220, when it is determined that the Bluetooth audio device 120 enters a call mode (such as a remote meeting), the Bluetooth audio device 120 can be switched to the hands-free profile mode 122 automatically by the device controller 130 or manually by the user. In step S230, when it is determined that the Bluetooth audio device 120 enters a music play mode (such as play a film or a song), the Bluetooth audio device 120 can be switched to the A2DP mode 124 automatically by the device controller 130 or manually by the user.

According to the Bluetooth connection system and the Bluetooth connection and setting method disclosed in above embodiments of the present application, the software of the computer system can be used to control the transmission unit to execute a search task, perform pairing and connect to a device (with only one click), then the transmission unit can transmit the instruction of switching to the pairing mode to the Bluetooth audio device. Or, the user can use the device controller to transmit data to the Bluetooth audio device. Or, the user can click the Bluetooth pairing key, then the Bluetooth audio device, through Bluetooth data transmission, will notify the control host to prepare for an automatic pairing procedure, hence avoiding the user spending a large amount of time with relevant Bluetooth settings due to his/her unfamiliarity with the computer system. According to the Bluetooth connection system and the Bluetooth connection and setting method of the present application, the smart selection module can switch between different profiles according to the scenario of use, the input to the Bluetooth audio device, the instruction received form the device controller, and/or the software in use, so that the microphone/speaker functions of the Bluetooth audio device will not be disabled and the user's enjoyment of listening to the music will not be affected due to the user's erroneous setting of the device.

While the present application has been described by way of example and in terms of the preferred embodiment(s), it is to be understood that the present application is not limited thereto. Based on the technical features embodiments of the present application, a person ordinarily skilled in the art will be able to make various modifications and similar arrangements and procedures without breaching the spirit and scope of protection of the present application. Therefore, the scope of protection of the present application should be accorded with what is defined in the appended claims.

What is claimed is:

1. A Bluetooth connection system, comprising:
a control host, comprising a transmission unit; and
a Bluetooth audio device used to wirelessly communicate with the transmission unit, wherein the control host receives an instruction, then turns on the transmission unit and executes a search task to find the Bluetooth audio device around the control host, the instruction is sent by an application program or the Bluetooth audio device,
when the Bluetooth audio device does not return a confirmation Bluetooth connection signal to the control host, the control host sends a wake-up signal to the Bluetooth audio device to start a re-pairing procedure.

2. The Bluetooth connection system according to claim 1, wherein before the control host completes pairing with the Bluetooth audio device, the control host deletes an old pairing data relevant to the Bluetooth audio device and accesses a new pairing data from the Bluetooth audio device again.

3. The Bluetooth connection system according to claim 2, wherein the control host pairs with the Bluetooth audio device using the new pairing data.

4. The Bluetooth connection system according to claim 1, wherein the control host comprises a smart selection module for switching an audio transmission mode of the Bluetooth audio device according to a scenario of use.

5. The Bluetooth connection system according to claim 1, further comprising a device controller, wherein the device controller wirelessly communicates with the Bluetooth audio device and switches the audio transmission mode of the Bluetooth audio device according to a scenario of use.

6. The Bluetooth connection system according to claim 4, wherein the audio transmission mode of the Bluetooth audio device comprises a hands-free profile mode and an abbreviation for advanced audio distribution profile (A2DP) mode; when the smart selection module determines that the Bluetooth audio device enters a call mode, the smart selection module switches the Bluetooth audio device to the hands-free profile mode;
when the smart selection module determines that the Bluetooth audio device enters a music play mode, the smart selection module or the device controller switches the Bluetooth audio device to the A2DP mode.

7. The Bluetooth connection system according to claim 6, wherein when the Bluetooth audio device ends the call mode and enters the music play mode, the smart selection module switches the Bluetooth audio device from the hands-free profile mode to the A2DP mode.

8. The Bluetooth connection system according to claim 6, wherein when the Bluetooth audio device ends the music play mode and enters the call mode, the smart selection module switches the Bluetooth audio device from the A2DP mode to the hands-free profile mode.

9. The Bluetooth connection system according to claim 6, wherein the control host comprises a control software unit, a voice call software and a music play software; the control software unit is used to control the voice call software supporting the hands-free profile mode and control the music play software supporting the A2DP mode to play an audio source.

10. The Bluetooth connection system according to claim 9, wherein the control software unit selects to turn on the voice call software or the music play software according to a switch instruction received from the smart selection module.

11. A Bluetooth connection method, comprising:
receiving an instruction by a control host to turn on a transmission unit and execute a search task to find a Bluetooth audio device around the control host, wherein the instruction is sent by an application program or the Bluetooth audio device;
determining whether the Bluetooth audio device returns a confirmation Bluetooth connection signal;
when it is determined that the Bluetooth audio device does not return the confirmation Bluetooth connection signal to the control host, sending a wake-up signal to the Bluetooth audio device by the control host to start a re-pairing procedure; and
pairing with the control host by the Bluetooth audio device.

12. The Bluetooth connection method according to claim 11, wherein before the control host completes pairing with the Bluetooth audio device, the control host deletes an old pairing data relevant to the Bluetooth audio device and accesses a new pairing data from the Bluetooth audio device again.

13. The Bluetooth connection method according to claim 12, wherein the control host pairs with the Bluetooth audio device using the new pairing data.

14. The Bluetooth connection method according to claim 11, wherein the control host comprises a smart selection module, and the Bluetooth connection and setting method further comprises: switching an audio transmission mode of the Bluetooth audio device by the smart selection module according to a scenario of use.

15. The Bluetooth connection method according to claim 11, further comprising wirelessly communicating with the Bluetooth audio device by a device controller and switching an audio transmission mode of the Bluetooth audio device according to a scenario of use.

16. The Bluetooth connection method according to claim 14, wherein the audio transmission mode of the Bluetooth audio device comprises a hands-free profile mode and an abbreviation for advanced audio distribution profile (A2DP) mode, and the Bluetooth connection and setting method further comprises:
when the smart selection module determines that the Bluetooth audio device enters a call mode, switching the Bluetooth audio device to the hands-free profile mode by the smart selection module; and
when the smart selection module determines that the Bluetooth audio device enters a music play mode, switching the Bluetooth audio device to the A2DP mode by the smart selection module.

17. The Bluetooth connection method according to claim 16, wherein the Bluetooth connection and setting method further comprises:
when the smart selection module determines that the Bluetooth audio device ends the call mode and enters the music play mode, switching the Bluetooth audio device from the hands-free profile mode to the A2DP mode by the smart selection module.

18. The Bluetooth connection method according to claim 16, further comprising:
when the smart selection module determines that the Bluetooth audio device ends the music play mode and enters the call mode, switching the Bluetooth audio device from the A2DP mode to the hands-free profile mode by the smart selection module.

19. The Bluetooth connection and setting method according to claim 16, wherein the control host comprises a control software unit, a voice call software and a music play software; the control software unit is used to control the voice call software supporting the hands-free profile mode and control the music play software supporting the A2DP mode to play an audio source.

20. The Bluetooth connection method according to claim 19, further comprising:
selecting to turn on the voice call software or the music play software by the control software unit according to a switch instruction received from the smart selection module.
